(19) United States
(12) Patent Application Publication
(10) Pub. No.: US 2025/0328184 A1
(43) Pub. Date: Oct. 23, 2025

(54) POWER SUPPLY METHOD, HARD DISK AND COMPUTING DEVICE

(71) Applicant: xFusion Digital Technologies Co., Ltd., Zhengzhou (CN)

(72) Inventors: Yonggui Liang, Zhengzhou (CN); Yimin Yao, Zhengzhou (CN)

(21) Appl. No.: 19/258,597

(22) Filed: Jul. 2, 2025

Related U.S. Application Data
(63) Continuation of application No. PCT/CN2023/135730, filed on Nov. 30, 2023.

(30) Foreign Application Priority Data
Jan. 11, 2023 (CN) 202310080392.6

(51) Int. Cl. G06F 1/3234; G06F 1/3221; G06F 1/3296

(52) U.S. Cl. CPC G06F 1/3268; G06F 1/3221; G06F 1/3296

(57) ABSTRACT

A power supply method, a hard disk and a computing device are provided. The method is applied to the hard disk, where the hard disk includes a main control chip and a plurality of storage blocks, and each storage block is connected to the main control chip. The method includes: acquiring a state of a first storage block; where the first storage block is any one of the plurality of storage blocks; and the state includes an enabled state or an energy-saving state; when the state of the first storage block is the enabled state, supplying power to the first storage block at a rated power; and when the state of the first storage block is the energy-saving state, supplying power to the first storage block at an energy-saving power, or not supplying power to the first storage block; where the energy-saving power is lower than the rated power.

### CROSS-REFERENCE TO RELATED APPLICATIONS

This application is a continuation of International Application No. PCT/CN2023/135730, filed on Nov. 30, 2023, which claims priority to Chinese Patent Application No. 202310080392.6, filed on Jan. 11, 2023 and entitled “POWER SUPPLY METHOD, HARD DISK AND COMPUTING DEVICE”, which is incorporated herein by reference in its entirety.

### TECHNICAL FIELD

Embodiments provided herein relate to the storage field, and in particular to a power supply method, a hard disk and a computing device.

### BACKGROUND

With the rapid development of the digital economy, various industries are gradually transforming to digitalization, and the scale of a data center continues to expand as the business volume increases. When each computing device of the data center stores, retrieves and shares digital information on the respective hard disk, the power consumption of each hard disk is low. However, when the entire data center has ten thousand hard disks, and the ten thousand hard disks run for 24 hours, the power consumption accounts for a large cost.

In conventional technology, the computing device controls a state of a hard disk by issuing instructions to the hard disk in the computing device. When there is no read/write request for the hard disk for a period of time, the computing device sends a hibernation instruction to the hard disk and supplies low power to the hard disk, to reduce power consumption. When there is a new read/write request for the hard disk, the computing device sends a wake-up instruction to the hard disk and supplies normal power to the hard disk.

In the conventional method, the computing device issues instructions to the entire hard disk. If the computing device continues to have a read/write request, normal power needs to be continuously supplied to the hard disk, resulting in high power consumption and failure to save energy.

### SUMMARY

Embodiments provided herein include a power supply method, a hard disk and a computing device, which can supply power in blocks based on states of a plurality of storage blocks in the hard disk, reducing power consumption of the hard disk and achieving energy saving.

To achieve the above technological purpose, embodiments provided herein include technical solutions including:

In a first aspect, an embodiment of the present disclosure provides a power supply method. The method is applied to a hard disk, the hard disk includes a main control chip and a plurality of storage blocks, and each storage block is connected to the main control chip, the method including: acquiring a state of a first storage block; where the first storage block is any one of the plurality of storage blocks; and the state includes an enabled state or an energy-saving state; when the state of the first storage block is the enabled state, supplying power to the first storage block at a rated power; and when the state of the first storage block is the energy-saving state, supplying power to the first storage block at an energy-saving power, or not supplying power to the first storage block; where the energy-saving power is lower than the rated power.

It is understandable that, during use of the hard disk, not all storage space is filled with written data at one time. Therefore, the storage space of the hard disk may be divided into a plurality of storage blocks, the main control chip in the hard disk respectively controls power supply to the plurality of storage blocks in the hard disk based on a state of each storage block, normal power is supplied to only a storage block in an enabled state, and low power is supplied to a storage block in an energy-saving state. The method may avoid continuously supplying power to an entire hard disk, which reduces power consumption and achieves power saving.

In a possible implementation, acquiring the state of the first storage block includes: supplying power to the first storage block at the rated power, and acquiring states of the plurality of storage blocks from the first storage block; where the states of the plurality of storage blocks are stored in the first storage block, and the states of the plurality of storage blocks include the state of the first storage block; or, after the hard disk is powered on, acquiring states of the plurality of storage blocks from the storage space; where the states of the plurality of storage blocks are stored in storage space included in the hard disk, and the states of the plurality of storage blocks include the state of the first storage block.

Understandably, the first storage block in the first implementation is any of the plurality of storage blocks, and the main control chip may acquire the states of the plurality of storage blocks once, including the state of the first storage block. The method acquires a state of each storage block without needing to supply power to all storage blocks sequentially, thus improving efficiency of acquiring the states of the plurality of storage blocks. Besides, the implementation is based on an existing storage block without altering a current hard disk architecture, and is highly implementable. The second implementation only needs to store the states of the plurality of storage blocks in the storage space, saving the storage space of the storage blocks, so that the hard disk may quickly acquire the states of the plurality of storage blocks, with simple operation steps.

In another possible implementation, the hard disk further includes a power supply module, and the main control chip controls the power supply module to provide a power supply power for the first storage block via a chip enable signal; and supplying power to the first storage block at the rated power includes: setting a level of the chip enable signal to a high level, to enable the power supply module to supply power to the first storage block at the rated power; and supplying power to the first storage block at the energy-saving power, or not supplying power to the first storage block, includes: setting the level of the chip enable signal to a low level, to enable the power supply module to supply power to the first storage block at the power-saving power, or not to supply power to the first storage block.

It is understandable that the chip enable signal is a mature technical solution. The power supply power of the first storage block is controlled based on the level of the chip enable signal, which can quickly achieve power supply in blocks to the plurality of storage blocks, reduce power consumption, and achieve energy saving.

In another possible implementation, the storage block includes a plurality of storage particles.

It is understandable that a size and a quantity of the storage particles corresponding to the storage block are not limited. Generally, to facilitate control and management of the main control chip, the storage block may include one or more die-granularity storage particles.

In another possible implementation, the method further includes: selecting a first target storage block and a second target storage block from the plurality of storage blocks; where the first target storage block is a storage block that is in an enabled state and has a highest wear level or a wear level greater than or equal to a first threshold, and the second target storage block is a storage block that is in an energy-saving state and has a lowest wear level or a wear level less than or equal to a second threshold; and the first threshold is greater than the second threshold; and when a difference between a wear level of the first target storage block and a wear level of the second target storage block is greater than or equal to a preset value, migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block.

It is understandable that when some storage blocks in the hard disk are in enabled states, the storage blocks may provide read/write services, and during a read/write process, wear levels of the storage blocks will be higher and higher. To avoid affecting overall performance of the hard disk due to the higher and higher wear levels of these storage blocks, data in the storage blocks is migrated to the other storage blocks, and the storage blocks stop continuing to be used, thus maintaining good performance of the hard disk.

In another possible implementation, before migrating the data stored in the first target storage block to the other storage blocks in the enabled states among the plurality of storage blocks, the method further includes: changing a state of the second storage block to an enabled state, and supplying power to the second storage block at the rated power.

It can be understood that the above method is a dynamic wear balance method, in which a storage block with a smaller wear level is changed from an energy-saving state to an enabled state, and a storage block with a higher wear level may migrate data to the storage block with the lower wear level. A storage block with a greater wear level in an enabled state is replaced with the storage block with the smaller wear level in the energy-saving state, so that differences between wear levels of the storage blocks in the hard disk remain within a certain range. The method ensures that read/write numbers of times of various storage blocks of the hard disk remain balanced, thereby maintaining good performance of the hard disk.

In another possible implementation, the method further includes: when a total remaining available capacity of a storage block in an enabled state among the plurality of storage blocks is less than or equal to a first preset value, selecting a second target storage block from a storage block in an energy-saving state among the plurality of storage blocks, and changing a state of the second target storage block to an enabled state, and supplying power to the second target storage block at the rated power; where the second target storage block is a storage block that is in an energy-saving state and has a lowest wear level or a wear level less than or equal to a second threshold.

It can be understood that in the above method, the main control chip dynamically expands the total remaining available capacity based on the size of the total remaining available capacity of the storage block in the enabled state. When the total remaining available capacity is small, in order to avoid service stalling, the main control chip first wakes up the storage block with the smaller wear level in the energy-saving state, and changes the storage block to be in the enabled state. The method ensures that when there is a new service, the current total remaining available capacity can meet running requirements of the new service.

In another possible implementation, the method further includes: when a total remaining available capacity of a storage block in an enabled state among the plurality of storage blocks is greater than or equal to a second preset value, selecting a first target storage block from a storage block in an enabled state among the plurality of storage blocks, and migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block; where the first target storage block is a storage block that is in an enabled state and has a highest wear level or a wear level greater than or equal to a first threshold.

It can be understood that in the above method, the main control chip dynamically contracts the total remaining available capacity based on the size of the total remaining available capacity of the storage block in the enabled state. When the total remaining available capacity is large, in order to reduce power consumption, the main control chip changes the storage block with the greater wear level in the enabled state to be in the energy-saving state. The method may achieve a certain energy-saving effect.

In another possible implementation, the main control chip is further connected to a cache chip; the cache chip caches physical location information of the plurality of storage blocks, the physical location information of the plurality of storage blocks includes a channel number, a chip enable signal and a capacity of each storage block in the hard disk; and the main control chip selects each storage block based on the physical location information.

It is understandable that the main control chip caches the physical location information of the plurality of storage blocks by setting the cache chip in the hard disk, so that the main control chip can quickly read location information of each storage block.

In another possible implementation, the above method further includes: when the state of the first storage block is the enabled state, and the main control chip detects that the first storage block in the enabled state is faulty, stopping supplying power to the first storage block in the enabled state.

Understandably, the main control chip stops supplying power to to the faulty first storage block in the enabled state, which can reduce power consumption of the hard disk and achieve energy saving.

In a second aspect, an embodiment provided herein provides a control apparatus, such as a main control chip in a hard disk, where the control apparatus is applied to each module of the power supply method in the first aspect or any one possible implementation of the first aspect.

In a third aspect, an embodiment provided herein provides a hard disk. The hard disk includes a main control chip and a plurality of storage blocks; where the main control chip is connected to the plurality of storage blocks; and the main control chip is configured to, based on a state of a first storage block, supply power to the first storage block, where the state includes an enabled state or an energy-saving state, and the first storage block is any one of the plurality of storage blocks; when the state of the first storage block is the enabled state, supply power to the first storage block at a rated power; and when the state of the first storage block is the energy-saving state, supply power to the first storage block at an energy-saving power, or not supply power to the first storage block; where the energy-saving power is lower than the rated power.

In a possible implementation, the hard disk further includes a cache chip; the cache chip is configured to cache physical location information of the plurality of storage blocks, and the physical location information of the plurality of storage blocks includes a channel number, a chip enable signal and a capacity of each storage block in the hard disk; and the main control chip selects each storage block based on the physical location information.

In a fourth aspect, an embodiment provided herein provides a computing device. The computing device includes a mainboard, a hard disk backplane and a hard disk; where the mainboard is connected to the hard disk by the hard disk backplane, the hard disk includes a main control chip and a plurality of storage blocks, and each storage block is connected to the main control chip; the hard disk is configured to, acquire a state of a first storage block; where the first storage block is any one of the plurality of storage blocks, and the state includes an enabled state or an energy-saving state; when the state of the first storage block is the enabled state, supply power to the first storage block at a rated power; and when the state of the first storage block is the energy-saving state, supply power to the first storage block at an energy-saving power, or not supply power to the first storage block; where the energy-saving power is lower than the rated power.

In a fifth aspect, an embodiment provided herein provides a control apparatus, including a memory and a processor. The memory is coupled with the processor; the memory is configured to store a computer program code, and the computer program code includes a computer instruction. When the processor executes the computer instruction, the control apparatus is caused to perform the power supply method of the first aspect and any one possible implementation thereof.

In a sixth aspect, an embodiment provided herein provides a computer-readable storage medium, including a computer instruction. When the computer instruction runs on the control apparatus, the control apparatus is caused to perform the power supply method of the first aspect and any one possible implementation thereof.

In a seventh aspect, an embodiment provided herein provides a computer program product, including a computer instruction. When the computer instruction runs on a control apparatus, the control apparatus is caused to perform the power supply method of the first aspect and any one possible implementation thereof.

For specific descriptions of the second aspect to seventh aspect and their various implementations in the embodiments provided herein, reference can be made to the first aspect and its various implementations; and for beneficial effects of the second aspect to the seventh aspect and their various implementations, reference can be made to analysis of the beneficial effects in the first aspect and its various implementations. The details will not be repeated here.

These or other aspects of the embodiments provided herein will become clearer and easier to understand in following descriptions.

### BRIEF DESCRIPTION OF DRAWINGS

FIG. 1 is a structural diagram of hardware involved in a power supply method according to an embodiment;

FIG. 2 is a structural diagram of a storage chip according to an embodiment;

FIG. 3 is a structural diagram of a computing device according to an embodiment;

FIG. 4 is a flowchart of a power supply method according to an embodiment;

FIG. 5 is a flowchart of a dynamic wear balance method according to an embodiment;

FIG. 6 is a flowchart of a dynamic capacity expansion and contraction method according to an embodiment; and

FIG. 7 is a structural diagram of a control apparatus according to an embodiment.

### DESCRIPTION OF EMBODIMENTS

Hereinafter, terms “first”, “second” and “third” are used only for descriptive purposes, and should not be interpreted as indicating or implying relative importance or implicitly specifying a quantity of indicated technical features. Thus, a feature defined with “first”, “second” or “third” may explicitly or implicitly include one or more of such features.

In conventional technology, the computing device controls a state of a hard disk by issuing an instruction to the hard disk in the computing device. When there is no read/write request for the hard disk for a period of time, the computing device sends a hibernation instruction to the hard disk, and supplies low power to the hard disk, to reduce power consumption. When there is a new read/write request for the hard disk, the computing device sends a wake-up instruction to the hard disk and supplies normal power to the hard disk. In the conventional method, the computing device issues an instruction to the entire hard drive. Therefore, if the computing device continues to have a read/write request, normal power needs to be continuously supplied to the hard disk, resulting in high power consumption and failure to save energy.

Based on this, embodiments provided herein provide a power supply method. The power supply method is applied to a main control chip of the hard disk. In the method, the main control chip may respectively control a plurality of storage blocks in the hard disk. Specifically, for any one storage block, when a state of the storage block is an enabled state, power is supplied to the storage block at a rated power; and when the state of the storage block is a power-saving state, power is supplied to the storage block at a power-saving power, or power is not supplied to the storage block.

It is understandable that, during use of the hard disk, not all storage space is filled with written data at one time. Therefore, the storage space of the hard disk may be divided into a plurality of storage blocks, the main control chip in the hard disk respectively controls power supply to the plurality of storage blocks in the hard disk based on a state of each storage block, normal power is supplied to only a storage block in an enabled state, and low power is supplied or no power is supplied to a storage block in an energy-saving state. The method may avoid continuously supplying power to an entire hard disk, which reduces power consumption and achieves power saving.

The following, in combination with accompanying drawings, provides a detailed description of implementations of the embodiments provided herein.

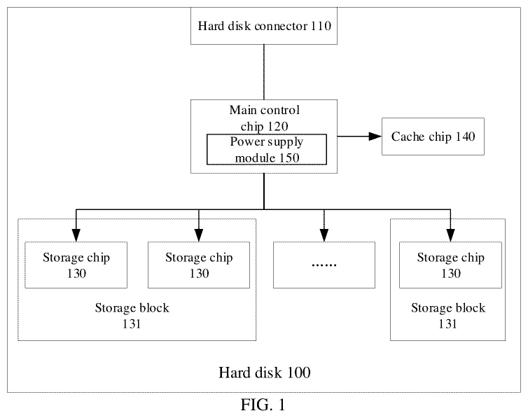

As shown in FIG. 1, FIG. 1 is a structural diagram of hardware involved in a power supply method according to an embodiment provided herein. As shown in FIG. 1, the hard disk 100 may include: a hard disk connector 110, a main control chip 120, a storage chip 130, and a cache chip 140 (optional).

The hard disk 100 is a type of hard disk made of a solid-state electronic storage chip array, such as a solid-state drive.

The hard disk connector 110 is configured to provide an interface externally and connected to the main control chip 120 internally. The hard disk connector 110 is configured to be electrically connected to a mainboard of the computing device, enabling communication with the mainboard.

The main control chip 120 is a core component in the hard disk, serving as command, operation and collaboration functions. For example, the main control chip 120 is a system on chip (SoC), which may be based on an advanced RISC machines (ARM) architecture, or a reduced instruction set computer (RISC) architecture, and possesses operational capabilities at a level similar to that of a central processing unit (CPU). In an embodiment provided herein, the main control chip 120 is configured to control a state (including an enabled state and a power-saving state) and a power supply condition of each storage block 131, and control data read/write and migration. Optionally, the main control chip 120 is further connected to the cache chip 140.

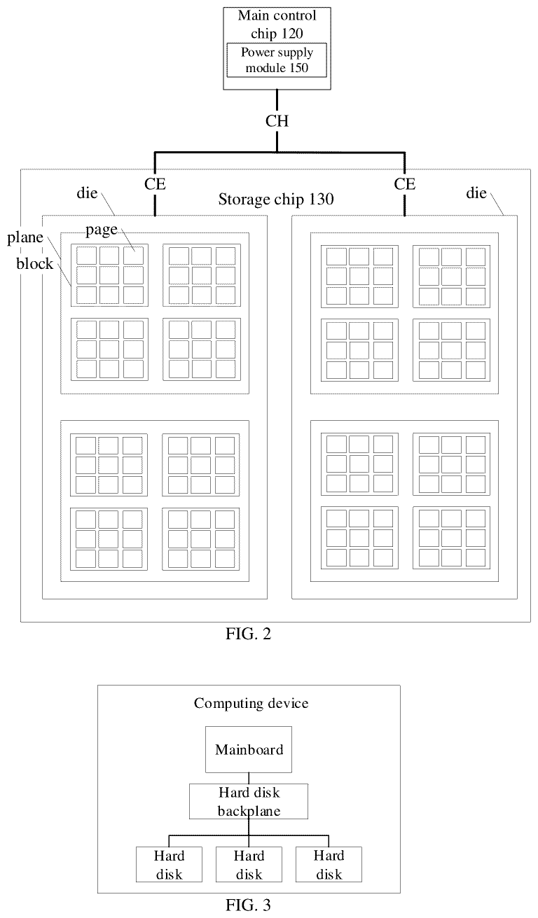

The storage chip 130 is a chip obtained by packaging storage particles in the hard disk. A plurality of storage chips 130 are included in the hard disk. As shown in FIG. 2, FIG. 2 shows a structural diagram of the storage chip 130.

The hard disk packages the plurality of storage chips 130. The storage chip 130 may include a plurality of die-granularity storage particles (for example, NAND flash storage particles), and the main control chip 120 may select each die-granularity storage particle via a chip enable (CE) signal. The storage chip 130 further includes a plane-granularity storage particle, a block-granularity storage particle, a page-granularity storage particle and a smaller granularity storage particle. A relationship among die, plane, block, and page includes that: each die includes a plurality of planes; each plane includes a plurality of blocks, and each block is a minimum unit for flash memory data erase; each block includes a plurality of pages, and the page is a minimum unit for flash memory read/write.

In a possible implementation, the storage block 131 is obtained by grouping the plurality of die-granularity storage particles included in the storage chip 130. For the structure of the storage chip 130 shown in FIG. 2, since the storage chip 130 is obtained by packaging one or more die-granularity storage particles, the storage block 131 may include one or more storage chips 130, or the storage block 131 may include partial space in the storage chip 130.

In fact, the storage block 131 may include a storage particle at a finer or coarser granularity than the die granularity. For example, the storage block 131 may include a plurality of plane-granularity storage particles.

As shown in FIG. 2, the main controller chip 120 may connect a plurality of storage blocks 131 and control power supply powers of the plurality of storage blocks 131 via a channel (CH) and the chip enable (CE) signal.

Optionally, the hard disk further includes a power supply module 150. The power supply module 150 is a hardware structure capable of achieving power supply to the plurality of storage blocks 131. The power supply module 150 may be integrated within the main control chip 120, or may be independently configured outside the main control chip 120, to be electrically connected to the main control chip 120 and the plurality of storage blocks 131. The main control chip 120 may control the power supply module 150 to provide a power supply power for each storage block 131 via the chip enable signal.

In a possible implementation, when a level of the chip enable signal is set to a high level, a power supply power of the power supply module is a rated power; when the level of the chip enable signal is set to a low level, the power supply power of the power supply module is a power-saving power or no power is supplied. For example, for a storage block CH1-CE1, the main control chip 120 sets a chip enable signal of CH1-CE1 to CE1-1 and sends a level value of the chip enable signal to the power supply module to control the power supply module to supply power to the storage block CH1-CE1 at the rated power; alternatively, the main control chip 120 sets the chip enable signal of CH1-CE1 to CE1-0 and sends the level value of the chip enable signal to the power supply module to control the power supply module to supply power to the CH1-CE1 storage block at the power-saving power, or not to supply power to the storage block CH1-CE1.

In another possible implementation, a circuit of the chip enable signal is integrated with a power supply circuit of the power supply module. When the main control chip 120 sets the level of the chip enable signal to a high level, the power supply module 150 supplies power at the rated power. When the main control chip 120 sets the level of the chip enable signal to a low level, the power supply module 150 supplies power at an energy-saving power or does not supply power. For example, for the storage block CH1-CE1, when the main control chip 120 sets the chip enable signal of CH1-CE1 to CE1-1, the power supply module 150 automatically supplies power to the storage block CH1-CE1 at the rated power. When the main control chip 120 sets the chip enable signal of CH1-CE1 to CE1-0, the power supply module 150 automatically supplies power to the storage block CH1-CE1 at the rated power, or does not supply power to the storage block CH1-CE1.

The foregoing is merely a possible implementation method in which the main control chip 120 provided in an embodiment provided herein controls the power supply module 150 to provide the power supply power for the plurality of storage blocks 131, which is not limited in actual implementation.

The cache chip 140 serves as a temporary storage buffer when the hard disk reads/writes data, to accelerate a data read/write speed of the hard disk. In an embodiment provided herein, the cache chip may be configured to cache physical location information, states, wear levels, and/or flash translation layer (FTL) tables of the plurality of storage blocks. The physical location information of the plurality of storage blocks includes a channel number, a chip enable signal, and a capacity of each storage block in the hard disk. Generally, information such as the above physical location information, states, wear levels, and/or FTL tables may further be stored in designated storage space, such as in each storage block. After the hard disk is powered on, the main control chip loads the above information from any storage block into the cache chip for convenience of reading and updating the above information. Before the hard disk is powered off, the above information is updated in the cache chip 140 and then synchronized and stored in the designated storage space. Of course, the hard disk may further include a non-volatile memory. The non-volatile memory may be set in the main control chip, or may be set outside the main control chip and electrically connected to the main control chip. The designated storage space may further be the non-volatile memory.

For example, the cache chip 140 may be a dynamic random access memory (DRAM).

As shown in FIG. 3, FIG. 3 is a structural diagram of a computing device according to an embodiment provided herein. The computing device includes a mainboard, a hard disk backplane, and a hard disk. The mainboard is connected to the hard disk by the hard disk backplane. The hard disk may be the hard disk 100 shown in FIG. 1. A quantity of hard disks in the computing device may be one or more, and the quantity of the hard disks in the computing device is not limited in embodiments provided herein.

The following describes a power supply method according to an embodiment provided herein.

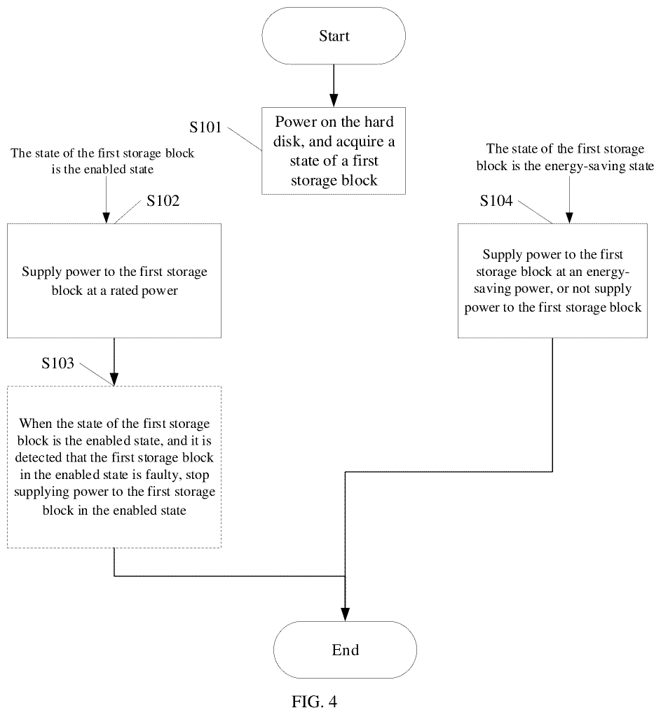

FIG. 4 is a flowchart of a power supply method according to an embodiment provided herein. The method is applied to a main control chip of a hard disk. The main control chip is connected to a plurality of storage blocks in the hard disk. The plurality of storage blocks may be either all or some of storage blocks in the hard disk. As shown in FIG. 4, the method may include S101 to S104.

S101: Power on the hard disk, and the main control chip acquires a state of a first storage block.

The first storage block is any one of the plurality of storage blocks; and the state includes an enabled state or an energy-saving state.

When the state of the first storage block is the enabled state, perform S102;

When the state of the first storage block is the energy-saving state, perform S104.

The enabled state indicates that the storage block is being enabled and may provide a normal read/write service and the energy-saving state indicates that the storage block is closed or hibernated and is unable to provide a normal read/write service.

Information of the state of the first storage block may be saved in any storage block, or in the main control chip.

In a possible implementation, the first storage block stores states of the plurality of storage blocks in the first storage block, and after the hard disk is powered on, power is supplied to the first storage block at a rated power, and the states of the plurality of storage blocks are acquired from the first storage block; where the states of the plurality of storage blocks include the state of the first storage block.

The first storage block in the above implementation is any of the plurality of storage blocks, and the main control chip may acquire the states of the plurality of storage blocks once, including the state of the first storage block. The method acquires a state of each storage block without needing to supply power to all storage blocks sequentially, thus improving efficiency of acquiring the states of the plurality of storage blocks. Meanwhile, the implementation is based on an existing storage block without altering a current hard disk architecture, and is highly implementable.

In another possible implementation, the hard disk includes storage space, such as a non-volatile storage chip. The storage space may be configured within or outside the main control chip, and electrically connected to the main control chip. The storage space is used for storing states of a plurality of storage blocks. After the hard disk is powered on, the states of the plurality of storage blocks are acquired from the storage space; the states of the plurality of storage blocks include the state of the first storage block.

The above implementation only needs to store the states of the plurality of storage blocks in the storage space, saving the storage space of the storage blocks, so that the hard disk may quickly acquire the states of the plurality of storage blocks, with simple operation steps.

For whether the hard disk is powered on for a first time, state configuration modes of the plurality of storage blocks vary.

In an implementation, when the hard disk is powered on for the first time, the states of the plurality of storage blocks in the hard disk are preset states, among which states of some storage blocks are enabled states and states of some other storage blocks are energy-saving states.

When the above hard disk is initialized, the states of the some storage blocks are preset to be the enabled states, while the states of the some other storage blocks are preset to be the power-saving states. The preset states may be stored either in designated space of each storage block or in storage space of the main control chip. The preset states ensure that the some storage blocks of the hard disk provide normal read/write services, while the some other storage blocks reduce power consumption.

In another implementation, when the hard disk is not powered on for the first time, the states of the plurality of storage blocks in the hard disk are states saved before the hard disk is powered off last time.

During use of the above hard disk, the main control chip adjusts a state of each storage block based on an actual usage situation, and saves the current state of each storage block before being powered off. When powered on next time, the main control chip may continue to supply power to each storage block based on a previous state of each storage block.

S102: The main control chip supplies power to the first storage block at the rated power.

The rated power is a power that allows the first storage block to operate normally (that is, to provide a normal read/write service). The rated power may be a power preset based on a capacity size of the first storage block.

In a possible implementation, the hard disk further includes a power supply module, and the main control chip controls the power supply module to provide a power supply power for the first storage block via a chip enable signal. For example, the main control chip sets a level of the chip enable signal to a high level, to enable the power supply module to supply power to the first storage block at the rated power.

The chip enable signal is a mature technical solution. The power supply module is controlled to provide the power supply power for the first storage block based on the level of the chip enable signal, which can quickly achieve power supply in blocks to the plurality of storage blocks, reduce power consumption, and achieve energy saving.

Optionally, in an enabled state, the first storage block may provide a data read/write service.

For example, the hard disk stores an FTL table. The FTL table is a conversion table of a corresponding relationship between a logical block address (LBA) maintained within the hard disk and a physical address of actual storage space within the hard disk. The main control chip controls physical space where data to be read/written is actually stored in the first storage block based on the table.

S103 (Optional): When the state of the first storage block is the enabled state, and the main control chip detects that the first storage block in the enabled state is faulty, the main control chip stops supplying power to the first storage block in the enabled state.

In this case, the main control chip may stop supplying power to the faulty first storage block in the enabled state, to achieve an energy-saving effect, and may change a state of the faulty first storage block to a fault state.

The fault state may be used to indicate that the storage block in the state is faulty and does not participate in a normal read/write operation subsequently. Setting the fault state may prevent the main control chip from selecting the faulty storage block, thereby reducing waste of computing resources. Meanwhile, which storage blocks are faulty may be prompted, which facilitates personnel to take relevant measures timely for repair.

After S103 is performed, a process of supplying power to the first storage block is completed.

S104: The main control chip supplies power to the first storage block at an energy-saving power, or does not supply power to the first storage block.

When the main control chip supplies power to the first storage block at the energy-saving power, or does not supply power to the first storage block, the first storage block enters the energy-saving state.

The energy-saving power is a power that allows the first storage block to be hibernated, and the energy-saving power is lower than the rated power.

If the main control chip does not supply power to the first storage block, the first storage block is closed. A difference between hibernated and closed lies in the fact that the main control chip may wake up a hibernated storage block more quickly and enable the storage block to enter an enabled state.

In a possible implementation, the hard disk further includes a power supply module, and the main control chip controls the power supply module to provide the power supply power for the first storage block via the chip enable signal. For example, the main control chip sets a level of the chip enable signal to a low level, to enable the power supply module to supply power to the first storage block at the energy-saving power or not to supply power to the storage block.

When power is supplied to the first storage block in the energy-saving state at the energy-saving power, or power is not supplied to the first storage block in the energy-saving state, the storage block does not provide the data read/write service. In this case, the storage block can reduce the overall power consumption of the hard disk.

In the power supply method in an embodiment provided herein, during use of the hard disk, not all storage space is filled with written data at one time. Therefore, the storage space of the hard disk may be divided into a plurality of storage blocks, the main control chip in the hard disk respectively controls power supply to the plurality of storage blocks in the hard disk based on the state of each storage block, normal power is supplied to only a storage block in an enabled state, and low power is supplied to a storage block in an energy-saving state. The method may avoid continuously supplying power to an entire hard disk, which reduces power consumption and achieves power saving.

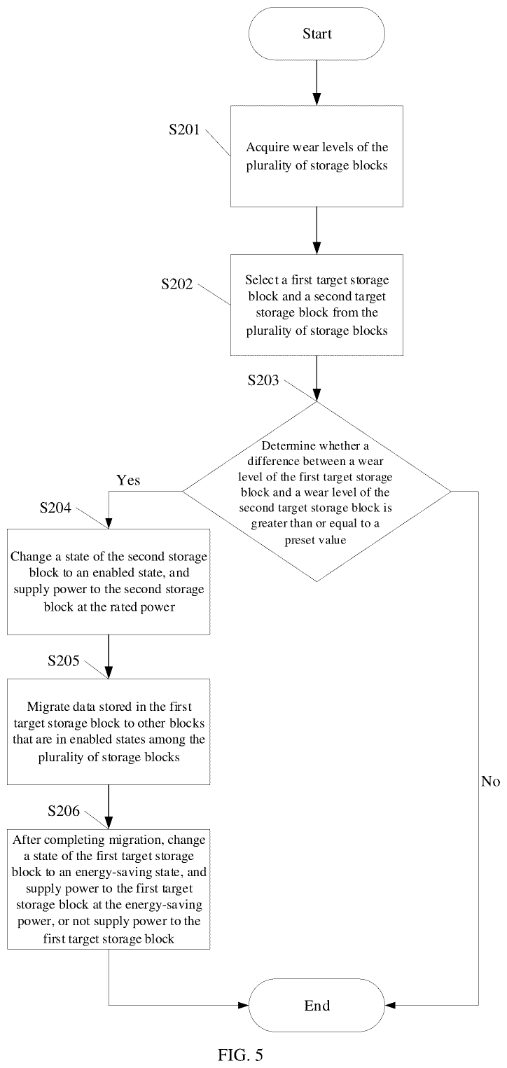

As shown in FIG. 5, FIG. 5 is a flowchart of a dynamic wear balance method according to an embodiment provided herein. After the hard disk shown in FIG. 4 is powered on for a period of time, the main control chip may perform steps shown in FIG. 5 at an interval of a preset time period or at a preset moment. The steps shown in FIG. 5 include S201 to S206.

S201: The main control chip acquires wear levels of the plurality of storage blocks.

The wear level is used to represent a service life of a storage block. The wear level may be represented by a total wear count of the storage block. The wear count is a number of times data in the storage block has been erased. Each time any storage space (for example: block) in the storage block is erased, the total wear count of the storage block is incremented by once. The higher the wear level of the storage block, the shorter the service life.

In the current method, the wear levels of the plurality of storage blocks are stored in designated storage space, and the main control chip acquires the wear levels of the plurality of storage blocks from the designated storage space.

S202: The main control chip selects a first target storage block and a second target storage block from the plurality of storage blocks.

The first target storage block is a storage block that is in an enabled state and has a highest wear level or a wear level greater than or equal to a first threshold, and the second target storage block is a storage block that is in an energy-saving state and has a lowest wear level or a wear level less than or equal to a second threshold; and the first threshold is greater than the second threshold.

In an example, the main control chip selects, from the wear levels of the plurality of storage blocks stored in the designated storage space, a first target storage block with a highest wear level in an enabled state, and a second target storage block with a lowest wear level in an energy-saving state.

In the example, generally, there is one first target storage block and one second target storage blocks. If there are a plurality of first target storage blocks with the highest wear level, or a plurality of second target storage blocks with the lowest wear level, one first target storage block or second target storage block is arbitrarily selected from the plurality of first target storage blocks or the plurality of second target storage blocks. Selecting the storage blocks with the highest and lowest wear levels facilitates subsequent dynamic wear balance at a minimum cost, thus conserving computing resources.

In another example, the main control chip selects, based on the wear levels of the plurality of storage blocks stored in the designated storage space, a first target storage block with a wear level greater than or equal to a first threshold in an enabled state, and a second target storage block with a wear level less than or equal to a second threshold in an energy-saving state.

In the example, there may be a plurality of first target storage blocks and a plurality of second target storage blocks respectively. By selecting the first target storage blocks and the second target storage blocks through the method, more storage blocks with wear levels reaching a certain threshold can subsequently enter the energy-saving state, so that a wear level of each storage blocks is more balanced, thus maintaining better performance for the hard disk.

S203: The main control chip determines whether a difference between a wear level of the first target storage block and a wear level of the second target storage block is greater than or equal to a preset value.
If yes, perform S204;
If no, the process ends.

The preset value is a value preset in the hard disk. The preset value may be customized based on a capacity size of the storage block. A storage block with a larger capacity can withstand a greater wear level, in which case, the preset value set based on the storage block with the larger capacity is also greater; and a storage block with a smaller capacity can withstand a smaller wear level, in which case, the preset value set based on the storage block with the smaller capacity is less than the preset value set for the storage block with the larger capacity.

The first target storage block is a storage block with a higher wear level among storage blocks in enabled states, and the second target storage block is a storage block with a lower wear level in a power-saving state. When a difference between the wear level of the first target storage block and the wear level of the second target storage block is greater than the preset value, it indicates that there is a significant difference between the wear level of the first target storage block and the wear level of the second target storage block.

When there are a plurality of first target storage blocks, and there are a plurality of second target storage blocks, if a difference between a wear level of any one first target storage block and a wear level of any one second target storage block is greater than or equal to the preset value, it is deemed that the condition of S202 is satisfied. That is, as long as the difference between the wear level of the first target storage block and the wear level of the second target storage block is greater than or equal to the preset value, S203 may be performed.

S204: The main control chip changes a state of the second storage block to an enabled state, and supplies power to the second storage block at the rated power.

S205: The main control chip migrates data stored in the first target storage block to other blocks in enabled states among the plurality of storage blocks.

Optionally, before the main control chip migrates the data stored in the first target storage block to the other storage blocks in the enabled states among the plurality of storage blocks, the main control chip may change the state of the first target storage block to a disabled state, indicating that the storage block is performing data migration and does not provide a read/write service. The disabled state is a transitional state; when other processes of the main control chip identify that the storage block is being in the disabled state, no data read/write operation is performed on the storage block. The method effectively prevents the other processes in the main control chip from performing data read/write on the storage block, reducing a data read/write error.

S206: After completing migration, the main control chip changes the state of the first target storage block to the energy-saving state, and supplies power to the first target storage block at the energy-saving power, or does not supply power to the first target storage block.

S204 may be performed before S205, after S206, or concurrently with S205, and a performing order of whether S204 is before or after S205 and S206 is not limited in embodiments provided herein. Generally, a solution where S204 is performed before S205 is preferred. In this case, when data migration is performed in S205, data may be migrated to the second target storage block in S204.

Steps shown in FIG. 5 are a dynamic wear balance method according to embodiments provided herein. When some storage blocks in the hard disk are in enabled states, the some storage blocks may provide read/write services, and during a read/write process, wear levels of the some storage blocks will be higher and higher. To avoid that the wear levels of some storage blocks are higher and higher while other storage blocks remain unused, an embodiment provides the dynamic wear balance method shown in FIG. 5. The storage blocks with the higher wear levels in the enabled states are replaced with those with the lower wear levels in the energy-saving state, ensuring that differences between wear levels of the storage blocks in the hard disk are maintained within a certain range. The method ensures that read/write numbers of times of various storage blocks of the hard disk remain balanced, thereby maintaining good performance of the hard disk.

In some embodiments, the dynamic wear balance method provided in an embodiment may be performed after the above power supply method, or may be performed with the power supply method during a same period of time.

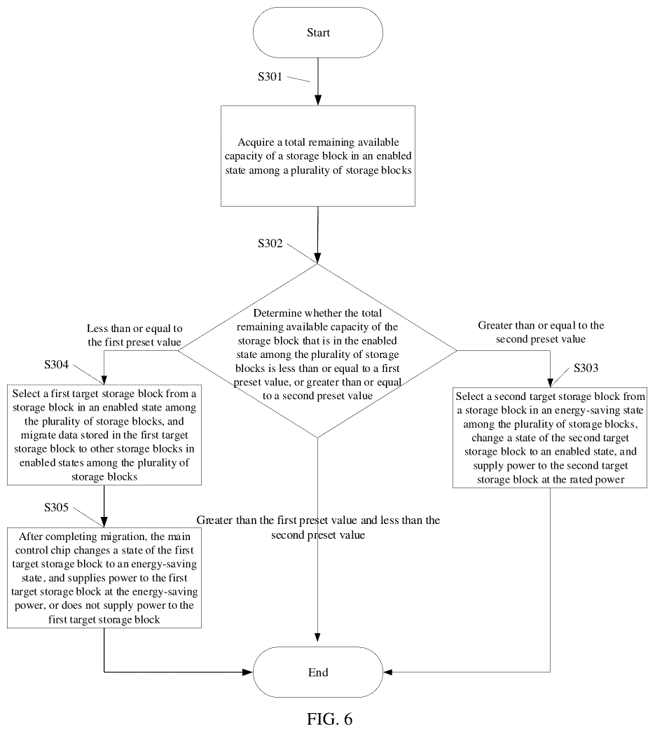

The following is a dynamic capacity expansion and contraction method provided based on the method shown in FIG. 4 in an embodiment. In other words, the power supply method shown in FIG. 4 may further include the dynamic capacity expansion and contraction method. As shown in FIG. 6, FIG. 6 is a flowchart of the dynamic capacity expansion and contraction method according to an embodiment provided herein. The dynamic capacity expansion and contraction method includes S301 to S305.

S301: The main control chip acquires a total remaining available capacity of a storage block in an enabled state among a plurality of storage blocks.

A remaining available capacity is a remaining available capacity of each storage block, and the total remaining available capacity is a sum of remaining available capacities of storage blocks in the enabled states among the plurality of storage blocks.

S302: The main control chip determines whether the total remaining available capacity of the storage block that is in the enabled state among the plurality of storage blocks is less than or equal to a first preset value, or greater than or equal to a second preset value.

The first preset value is less than the second preset value.

When the total remaining available capacity of the storage block in the enabled state among the plurality of storage blocks is greater than or equal to the second preset value, indicating that the total remaining available capacity of the storage block in the enabled state is large, capacity contraction may be performed, and S303 is performed.

When the total remaining available capacity of the storage block in the enabled state among the plurality of storage blocks is less than or equal to the first preset value, indicating that the total remaining available capacity of the storage block in the enabled state is small, capacity expansion may be performed, and S304 is performed.

When the total remaining available capacity of the storage block in the enabled state among the plurality of storage blocks is greater than or equal to the second preset value, indicating that the total remaining available capacity of the storage block in the enabled state is moderate, capacity expansion and contraction may not be performed, and the process ends.

S303: The main control chip selects a second target storage block from a storage block in an energy-saving state among the plurality of storage blocks, changes a state of the second target storage block to an enabled state, and supplies power to the second target storage block at the rated power.

The second target storage block is a storage block that is in an energy-saving state and has a lowest wear level or a wear level less than or equal to a second threshold.

In an example, the main control chip selects, from the wear levels of the plurality of storage blocks stored in designated storage space, the second target storage block with the lowest wear level in the energy-saving state or the wear level less than or equal to the second threshold.

After S303 is performed, the process ends.

S304: The main control chip selects a first target storage block from a storage block in an enabled state among the plurality of storage blocks, and migrates data stored in the first target storage block to other storage blocks in enabled states among the plurality of storage blocks.

The first target storage block is a storage block that is in an enabled state and has a highest wear level or a wear level greater than or equal to a first threshold.

In an example, the main control chip selects, from the wear levels of the plurality of storage blocks stored in the designated storage space, the first target storage block in the enabled state with the highest wear level or the wear level greater than or equal to the first threshold.

For specific descriptions of S304, refer to S205.

S305: After completing migration, the main control chip changes a state of the first target storage block to an energy-saving state, and supplies power to the first target storage block at the energy-saving power, or does not supply power to the first target storage block.

The first target storage block is a storage block that is in an enabled state and has a highest wear level or a wear level greater than or equal to a first threshold.

In the method shown in the above FIG. 6, the main control chip may monitor the total remaining available capacity of the storage block in the enabled state in real time. When the situation in S302 occurs, the total remaining available capacity of the storage block in the enabled state is dynamically adjusted until the total remaining available capacity of the storage block in the enabled state is between the first preset value and the second preset value.

Steps shown in FIG. 6 are the dynamic capacity expansion and contraction method according to an embodiment. In the method, the main control chip dynamically expands or contracts the total remaining available capacity based on the size of the total remaining available capacity of the storage block in the enabled state. When the total remaining available capacity is small, in order to avoid service stalling, the main control chip first wakes up the storage block with the smaller wear level in the energy-saving state, and changes the storage block to be in the enabled state. The method ensures that when there is a new service, the current total remaining available capacity can meet the running requirements of the new service. When the total remaining available capacity is large, in order to reduce power consumption, the main control chip changes the storage block with the greater wear level in the enabled state to be in the energy-saving state. The method may achieve a certain energy-saving effect.

Optionally, the hard disk shown in FIGS. 4, 5, and 6 further includes a cache chip connected to the main control chip. The cache chip stores physical location information of the plurality of storage blocks. The main control chip selects each storage block and controls a power supply power of each storage block based on the physical location information cached in the cache chip.

Further optionally, when the storage block includes one or more die-granularity storage particles, the above physical location information includes a channel number, a chip enable signal, and a capacity of each storage block in the hard disk. For example, a channel number of dies included in the first storage block in the hard disk is CH1, chip enable signals are CE1 and CE2, and capacities are 32G respectively, in which case the physical location information of the first storage block is: CH1-CE1-32G, CH1-CE2-32G.

Since a size and a quantity of storage particles corresponding to the above storage block are not limited, the physical location information may include more or less information. The embodiments provided herein do not limit specific content included in the physical location information. Generally, for convenience of control and management by the main control chip, the storage block includes one or more die-granularity storage chips.

The capacity of each storage block may be the same or different. Generally, for the convenience of control and management by the main control chip, a capacity of each storage block is generally set to same.

The above cache chip may further cache states and wear levels of the plurality of storage blocks. The main control chip loads the states and wear levels of the plurality of storage blocks stored in any one storage block into cache, facilitating faster read and update of the state and wear level of each storage block.

In an example, as shown in Table 1, Table 1 shows physical location information, states, and wear levels of the plurality of storage blocks cached in the cache chip. Table 1 includes “storage block”, “physical location information”, “state”, and “wear level”. “wear level” may be represented by a total wear count of a storage block.

TABLE 1

| | Physical location | | |
|---|---|---|---|
| Storage block | information | State | Wear level |
| Storage block 1 | CH1-CE1-64G | Enabled | 3000 |
| | CH1-CE2-64G | | |
| Storage block 2 | CH1-CE3-64G | Enabled | 2500 |
| | CH1-CE4-64G | | |
| Storage block 3 | CH2-CE1-64G | Energy-saving | 2000 |
| | CH2-CE2-64G | | |
| Storage block 4 | CH2-CE3-64G | Fault | 1500 |
| | CH2-CE4-64G | | |
| Storage block 5 | CH3-CE1-64G | Disabled | 2000 |
| | CH3-CE2-64G | | |
| . . . | . . . | . . . | . . . |
| Storage block n | CHm-CE1-64G | Energy-saving | 2000 |
| | CHm-CE2-64G | | |

During a process of performing data read/write on each storage block, the main control chip dynamically updates the state and wear level of each storage block in Table 1 based on an actual usage situation of each storage block. When the hard disk is powered off, the main control chip persists data in Table 1 cached in the cache chip to designated space in each storage block in the enabled state, which facilitates reading the data in Table 1 when the hard disk is powered on next time.

The above mainly introduces the solutions provided in the embodiments provided herein from the perspective of methodology. To achieve the above functions, hardware structures and/or software modules that perform each function are included. It should be readily apparent to the technical objective in the field that units and algorithm steps of various examples described with the embodiments disclosed herein may be implemented by hardware, or a combination of hardware and computer software. Whether a particular function is executed by hardware or software driving the hardware depends on a specific application and design constraints of the technical solution. A professional technical objective may adopt a different method for each specific application to implement the functions, but such an implementation shall not be considered beyond the scope of what is provided in the present embodiments.

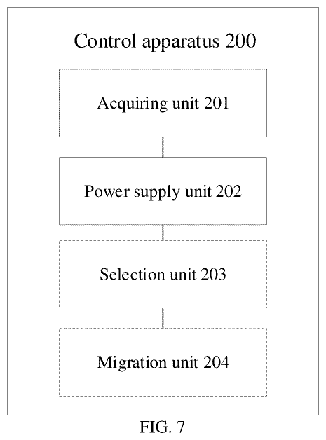

An embodiment further provides a control apparatus 200, such as the main controller chip in FIG. 1. FIG. 7 is a structural diagram of the control apparatus 200 according to an embodiment.

The control apparatus 200 includes an acquiring unit 201 and a power supply unit 202. The acquiring unit 201 is configured to acquire a state of a first storage block; where the first storage block is any one of the plurality of storage blocks; and the state includes an enabled state or an energy-saving state; when the state of the first storage block is the enabled state, the power supply unit 202 is configured to supply power to the first storage block at a rated power; and when the state of the first storage block is the energy-saving state, the power supply unit 202 is configured to supply power to the first storage block at an energy-saving power, or not supply power to the first storage block; where the energy-saving power is lower than the rated power. For example, as shown in FIG. 4, the acquiring unit 201 is used in S101 in the method embodiment, and the power supply unit 202 is used in S102 or S104 in the method embodiment.

Optionally, the acquiring unit 201 is specifically configured to, after the hard disk is powered on, supply power to the first storage block at the rated power, and acquire states of the plurality of storage blocks from the first storage block; where the states of the plurality of storage blocks are stored in in the first storage block, and the states of the plurality of storage blocks include the state of the first storage block; or, after the hard disk is powered on, acquire states of the plurality of storage blocks from the storage space; where the states of the plurality of storage blocks are stored in storage space included in the hard disk, and the states of the plurality of storage blocks include the state of the first storage block. For example, the acquiring unit 201 is used in S101 in the method embodiment.

In another possible implementation, the hard disk further includes a power supply module, and the main control chip controls the power supply module to provide a power supply power for the first storage block via a chip enable signal; and the power supply unit 202 is specifically configured to, set a level of the chip enable signal to a high level, to enable the power supply module to supply power to the first storage block at the rated power; and the power supply unit 202 is specifically configured to, set the level of the chip enable signal to a low level, to enable the power supply module to supply power to the first storage block at the power-saving power, or not to supply power to the first storage block. For example, the power supply unit 202 is used in S102 or S104 in the method embodiment.

Optionally, the storage block includes a plurality of storage particles.

Optionally, the control apparatus 200 further includes a selection unit 203. The selection unit 203 is configured to select a first target storage block and a second target storage block from the plurality of storage blocks; where the first target storage block is a storage block that is in an enabled state and has a highest wear level or a wear level greater than or equal to a first threshold, and the second target storage block is a storage block that is in an energy-saving state and has a lowest wear level or a wear level less than or equal to a second threshold; and the first threshold is greater than the second threshold. The control apparatus 200 further includes a migration unit 204. The migration unit 204 is configured to, when a difference between a wear level of the first target storage block and a wear level of the second target storage block is greater than or equal to a preset value, migrate data stored in the first target storage block to other storage blocks in enabled states among the plurality of storage blocks. The power supply unit 202 is further configured to, after completing migration, change a state of the first target storage block to an energy-saving state, and supply power to the first target storage block at the energy-saving power, or not supply power to the first target storage block. For example, as shown in FIG. 5, the selection unit 203 is used in S202 in the method embodiment, the migration unit 204 is used in S205 in the method embodiment, and the power supply unit 202 is used in S206 in the method embodiment.

In another possible implementation, the power supply unit 202 is further configured to, before migrating the data stored in the first target storage block to the other storage blocks in the enabled states among the plurality of storage blocks, change a state of the second storage block to an enabled state, and supply power to the second storage block at the rated power. For example, in combination with FIG. 5, the power supply unit 202 is used in S204 in the method embodiment.

Optionally, the selection unit 203 is further configured to, when a total remaining available capacity of a storage block in an enabled state among the plurality of storage blocks is less than or equal to a first preset value, select a second target storage block from a storage block in an energy-saving state among the plurality of storage blocks, and the power supply unit 202 is further configured to change a state of the second target storage block to an enabled state, and supply power to the second target storage block at the rated power; where the second target storage block is a storage block that is in an energy-saving state and has a lowest wear level or a wear level less than or equal to a second threshold. For example, as shown in FIG. 6, the selection unit 203 is used in S303 in the method embodiment, and the power supply unit 202 is used in S303 in the method embodiment.

In another possible implementation, the selection unit 203 is further configured to, when the total remaining available capacity of the storage block in the enabled state among the plurality of storage blocks is greater than or equal to a second preset value, select a first target storage block from a storage block in an enabled state among the plurality of storage blocks, and the migration unit 204 is further configured to, migrate data stored in the first target storage block to other storage blocks in enabled states among the plurality of storage blocks; and the power supply unit 202 is further configured to, after completing migration, change a state of the first target storage block to an energy-saving state, and supply power to the first target storage block at the energy-saving power, or not supply power to the first target storage block; where the first target storage block is a storage block that is in an enabled state and has a highest wear level or a wear level greater than or equal to a first threshold. For example, as shown in FIG. 6, the selection unit 203 is used in S304 in the method embodiment, the migration unit 204 is used in S304 in the method embodiment, and the power supply unit 202 is used in S305 in the method embodiment.

Optionally, the control apparatus 200 is further connected to a cache chip; the cache chip caches physical location information of the plurality of storage blocks, and the physical location information of the plurality of storage blocks includes a channel number, a chip enable signal and a capacity of each storage block in the hard disk; and the control apparatus 200 selects each storage block based on the physical location information.

Optionally, the power supply unit 202 is further configured to, when the state of the first storage block is the enabled state, and the control apparatus 200 detects that the first storage block in the enabled state is faulty, stop supplying power to the first storage block in the enabled state. For example, in combination with FIG. 4, the power supply unit 202 is used in S103 in the method embodiment.

Of course, the control apparatus 200 provided in various embodiments may include but is not limited to the above modules.

Another embodiment provided herein provides a control apparatus including a memory and a processor. The memory is coupled with the processor; the memory is configured to store a computer program code, and the computer program code includes a computer instruction. When the processor executes the computer instruction, the control apparatus is caused to perform each step of the power supply method shown in the above method embodiment.

In actual implementation, the acquiring unit 201, the power supply unit 202, the selection unit 203, and the migration unit 204 may be achieved by the processor calling the computer program code in the memory. The specific execution process may refer to the description in the above method part, and will not be repeated here.

Another embodiment further provides a computer-readable storage medium storing a computer instruction. When the computer instruction runs on a control apparatus, the control apparatus is caused to perform each step performed by the control apparatus in the power supply method process shown in the above method embodiment.

Another embodiment further provides a system on a chip. The system on a chip is applied to a control apparatus. The system on a chip includes one or more interface circuits and one or more processors. The interface circuit and the processor are interconnected through a line. The interface circuit is configured to receive a signal from a memory of the control apparatus and send the signal to the processor. The signal includes a computer instruction stored in the memory. When the processor of the control apparatus executes the computer instruction, the control apparatus is caused to perform each step performed by the control apparatus in the power supply method process shown in the above method embodiment.

Another embodiment further provides a computer program product storing a computer instruction. When the computer instruction runs on a control apparatus, the control apparatus is caused to perform each step performed by the control apparatus in the power supply method process shown in the above method embodiment.

The above embodiment may be implemented wholly or partly by software, hardware, firmware, or any combination thereof. When implemented using a software program, the above embodiment may be implemented wholly or partly in a form of the computer program product. The computer program product includes one or more computer instructions. When a computer execution instruction is loaded and executed on a computer, processes or functions in any of various embodiments provided herein are generated wholly or partly. The computer may be a general-purpose computer, a special-purpose computer, a computer network, a server or other programmable devices. The computer instruction may be stored in a computer-readable storage medium or transmitted from one computer-readable storage medium to another computer-readable storage medium. For example, the computer instruction may be transmitted from a website, computer, server, or data center to another website, computer, server, or data center by wired means (such as a coaxial line, an optical fiber, or a digital subscriber line (DSL)), or by wireless means (such as infrared, radio, microwave, etc.). The computer-readable storage medium may be any available medium accessible to the computer, or a data storage device integrating one or more available media, such as a server or a data center. The available medium may be a magnetic medium such as a floppy drive, a drive, or a tape, an optical medium such as a DVD, or a semiconductor medium such as a solid state disk (SSD).

The above descriptions are merely implementations of various exemplary embodiments. Variations or substitutions conceivable by those skilled in the art based on the implementations provided as embodiments herein, shall be covered within the scope of protection of what is provided.

1. A power supply method, applied to a hard disk, wherein the hard disk comprises a main control chip and a plurality of storage blocks, and each storage block is connected to the main control chip, the method comprising:
acquiring a state of a first storage block; wherein the first storage block is any one of the plurality of storage blocks; and the state comprises an enabled state or an energy-saving state;
when the state of the first storage block is the enabled state, supplying power to the first storage block at a rated power; and
when the state of the first storage block is the energy-saving state, supplying power to the first storage block at an energy-saving power, or not supplying power to the first storage block; wherein the energy-saving power is lower than the rated power.

2. The method according to claim 1, wherein acquiring the state of the first storage block comprises:
after the hard disk is powered on, supplying power to the first storage block at the rated power, and acquiring states of the plurality of storage blocks from the first storage block; wherein the states of the plurality of storage blocks are stored in the first storage block, and the states of the plurality of storage blocks comprise the state of the first storage block;
or, after the hard disk is powered on, acquiring states of the plurality of storage blocks from the storage space; wherein the states of the plurality of storage blocks are stored in storage space comprised in the hard disk, and the states of the plurality of storage blocks comprise the state of the first storage block.

3. The method according to claim 1, wherein the hard disk further comprises a power supply module, and the main control chip controls the power supply module to provide a power supply power for the first storage block via a chip enable signal; and supplying power to the first storage block at the rated power comprises:
setting a level of the chip enable signal to a high level, to enable the power supply module to supply power to the first storage block at the rated power; and
supplying power to the first storage block at the energy-saving power, or not supplying power to the first storage block, comprises:
setting the level of the chip enable signal to a low level, to enable the power supply module to supply power to the first storage block at the power-saving power, or not to supply power to the first storage block.

4. The method according to claim 1, wherein the storage block comprises a plurality of storage particles.

5. The method according to claim 1, further comprising:
selecting a first target storage block and a second target storage block from the plurality of storage blocks; wherein the first target storage block is a storage block that is in an enabled state and has a highest wear level or a wear level greater than or equal to a first threshold, and the second target storage block is a storage block that is in an energy-saving state and has a lowest wear level or a wear level less than or equal to a second threshold; and the first threshold is greater than the second threshold; and
when a difference between a wear level of the first target storage block and a wear level of the second target storage block is greater than or equal to a preset value, migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block.

6. The method according to claim 5, wherein, before migrating the data stored in the first target storage block to the other storage blocks in the enabled states among the plurality of storage blocks, the method further comprises:
changing a state of the second storage block to an enabled state, and supplying power to the second storage block at the rated power.

7. The method according to claim 1, further comprising:
when a total remaining available capacity of a storage block in an enabled state among the plurality of storage blocks is less than or equal to a first preset value, selecting a second target storage block from a storage block in an energy-saving state among the plurality of storage blocks, and changing a state of the second target storage block to an enabled state, and supplying power to the second target storage block at the rated power; wherein the second target storage block is a storage block that is in an energy-saving state and has a lowest wear level or a wear level less than or equal to a second threshold.

8. The method according to claim 1, further comprising:
when a total remaining available capacity of a storage block in an enabled state among the plurality of storage blocks is greater than or equal to a second preset value, selecting a first target storage block from a storage block in an enabled state among the plurality of storage blocks, and migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block; wherein the first target storage block is a storage block that is in an enabled state and has a highest wear level or a wear level greater than or equal to a first threshold.

9. A hard disk, comprising a main control chip and a plurality of storage blocks; wherein the main control chip is connected to the plurality of storage blocks; and the main control chip is configured to, based on a state of a first storage block, supply power to the first storage block, wherein the state comprises an enabled state or an energy-saving state, and the first storage block is any one of the plurality of storage blocks; when the state of the first storage block is the enabled state, supply power to the first storage block at a rated power; and when the state of the first storage block is the energy-saving state, supply power to the first storage block at an energy-saving power, or not supply power to the first storage block; wherein the energy-saving power is lower than the rated power.

10. The hard disk according to claim 9, further comprising a cache chip; wherein the cache chip is configured to cache physical location information of the plurality of storage blocks, the physical location information of the plurality of storage blocks comprises a channel number, a chip enable signal and a capacity of each storage block in the hard disk; and the main control chip is configured to select each storage block based on the physical location information.

11. A computing device, comprising a mainboard, a hard disk backplane and a hard disk;
wherein the mainboard is connected to the hard disk by the hard disk backplane, the hard disk comprises a main control chip and a plurality of storage blocks, and each storage block is connected to the main control chip; the hard disk is configured to:
acquire a state of a first storage block, wherein the first storage block is any one of the plurality of storage blocks, and the state comprises an enabled state or an energy-saving state;
when the state of the first storage block is the enabled state, supply power to the first storage block at a rated power; and
when the state of the first storage block is the energy-saving state, supply power to the first storage block at an energy-saving power, or cause power not to be supplied to the first storage block;
wherein the energy-saving power is lower than the rated power.

12. The method according to claim 3, wherein the storage block comprises a plurality of storage particles.

13. The method according to claim 12, further comprising:
selecting a first target storage block and a second target storage block from the plurality of storage blocks; wherein the first target storage block is a storage block that is in an enabled state and has a highest wear level or a wear level greater than or equal to a first threshold, and the second target storage block is a storage block that is in an energy-saving state and has a lowest wear level or a wear level less than or equal to a second threshold; and the first threshold is greater than the second threshold; and
when a difference between a wear level of the first target storage block and a wear level of the second target storage block is greater than or equal to a preset value, migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block.

14. The method according to claim 13, wherein, before migrating the data stored in the first target storage block to the other storage blocks in the enabled states among the plurality of storage blocks, the method further comprises:
changing a state of the second storage block to an enabled state, and supplying power to the second storage block at the rated power.

15. The method according claim 14, further comprising:
when a total remaining available capacity of a storage block in an enabled state among the plurality of storage blocks is less than or equal to a first preset value, selecting a second target storage block from a storage block in an energy-saving state among the plurality of storage blocks, and changing a state of the second target storage block to an enabled state, and supplying power to the second target storage block at the rated power; wherein the second target storage block is a storage block that is in an energy-saving state and has a lowest wear level or a wear level less than or equal to a second threshold.

16. The method according to claim 15, further comprising:
when a total remaining available capacity of a storage block in an enabled state among the plurality of storage blocks is greater than or equal to a second preset value, selecting a first target storage block from a storage block in an enabled state among the plurality of storage blocks, and migrating data stored in the first target storage block to other storage blocks in enabled states among the plurality of storage blocks; after completing migration, changing a state of the first target storage block to an energy-saving state, and supplying power to the first target storage block at the energy-saving power, or not supplying power to the first target storage block; wherein the first target storage block is a storage block that is in an enabled state and has a highest wear level or a wear level greater than or equal to a first threshold.
